(19) United States
(12) Patent Application Publication
(10) Pub. No.: US 2011/0047391 A1
(43) Pub. Date: Feb. 24, 2011

(54) ELECTRONIC DEVICE AND MOTHERBOARD THEREOF

(75) Inventor: Ming-Chih Hsieh, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/622,343

(22) Filed: Nov. 19, 2009

(30) Foreign Application Priority Data
Aug. 20, 2009 (CN) 200910305841.2

(51) Int. Cl. G06F 1/00

(52) U.S. Cl. 713/300

(57) ABSTRACT

An electrical device includes a motherboard and a daughter board. The daughter board includes a plurality of signal pins to output signals for denoting a type of the daughter board. The motherboard includes a controller and a voltage adjusting unit. The controller receives the signals from the signal pins of the daughter board to identify the type of the daughter board and outputs control signals according to the signals received from the daughter board. The voltage adjusting unit receives the control signals and adjusts a voltage from a voltage source into a work voltage according the control signal, and outputs the work voltage to the electrical element.

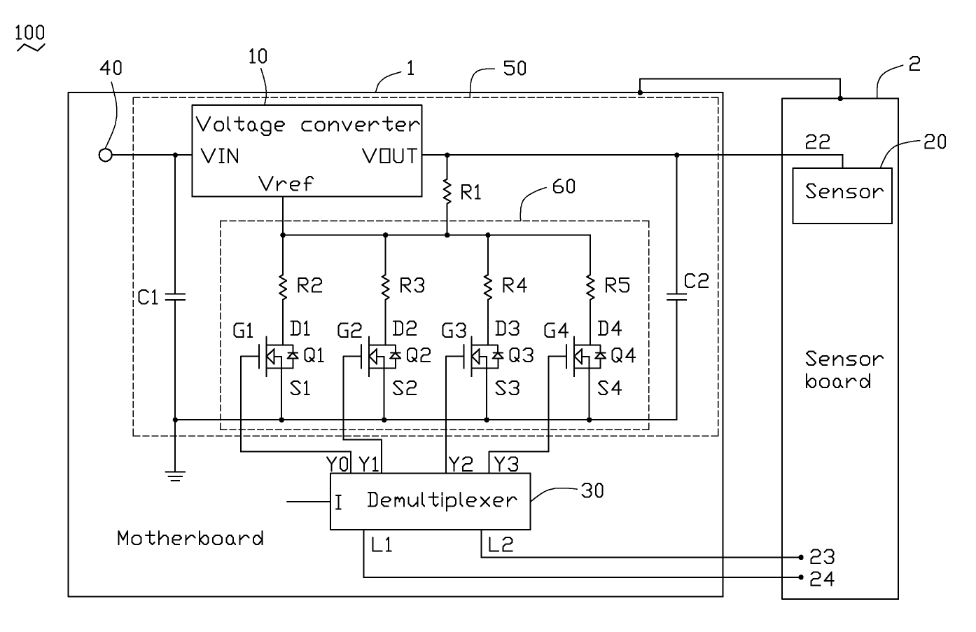

### BACKGROUND

1. Technical Field

The present disclosure relates to devices, and particularly to an electronic device and a motherboard thereof.

2. Description of Related Art

Digital multifunctional cameras such as network cameras include a motherboard and a sensor board. When the sensor board is connected to the motherboard, the motherboard supplies a work voltage for sensors mounted on the sensor board and a system voltage for the sensor board. The sensors may include complementary metal-oxide-semiconductor transistor image sensors and charge coupled device image sensors of which there are many different types and so can have different voltage demands. If a sensor board is changed, it is likely that the new sensor board will have different voltage needs and so the motherboard must be modified. It is inconvenient, time-consuming, and expensive to modify the motherboard.

### BRIEF DESCRIPTION OF THE DRAWINGS

The drawing is a block diagram of one embodiment of an electronic device.

### DETAILED DESCRIPTION

Referring to the drawing, an exemplary embodiment of an electronic device 100 includes a motherboard 1 and a daughter board such as a sensor board 2 connected to the motherboard 1. The motherboard 1 is used to supply system voltage to the sensor board 2 and work voltage to a plurality of electrical elements mounted on the sensor board 2. In the embodiments, the electronic device 100 is a network camera.

The sensor board 2 includes an electrical element such as a sensor 20 and two signal pins such as identity (ID) signal pins 23 and 24. The ID signal pins are used to output signals to denote a type of the sensor board 2. The sensor 20 is a complementary metal-oxide-semiconductor transistor (CMOS) image sensor. The motherboard 1 supplies a work voltage to the sensor 20 according to the type of the sensor 20.

The motherboard 1 includes a voltage adjusting unit 50 and a controller such as a demultiplexer 30 connected to the voltage adjusting unit 50 to output a control signal to the voltage adjusting unit to output the work voltage. The voltage adjusting unit 50 includes a voltage converter 10, a resistor regulator 60, a first capacitor C1, a second capacitor C2, a power terminal 40, and a first resistor R1. The voltage converter 10 includes a voltage input terminal VIN, a voltage output terminal VOUT, and a reference terminal Vref. The resistor regulator 60 includes a second to a fifth resistors R2-R5, and a first to a fourth electrical switches Q1-Q4. Each of the first to fourth electrical switches Q1-Q4 includes a control terminal, a first terminal, and a second terminal. The demultiplexer 30 includes two signal selecting pins L1 and L2, a signal input pin , and first to fourth signal output pins Y0-Y3.

The voltage input terminal VIN of the voltage converter 10 is connected to the power terminal 40. The voltage output terminal VOUT of the voltage converter 10 is connected to a voltage input terminal 22 of the sensor 20 mounted on the sensor board 2. The reference terminal Vref of the voltage converter 10 is connected to the first terminal D1 of the first electrical switch Q1 via the second resistor R2, the first terminal D2 of the second electrical switch Q2 via the third resistor R3, the first terminal D3 of the third electrical switch Q3 via the fourth resistor R4, and the first terminal D4 of the fourth electrical switch Q4 via the fifth resistor R5. The first resistor R1 is connected between the reference terminal Vref and the voltage output terminal VOUT of the voltage converter 10. The second terminals S1-S4 of the first to fourth electrical switches Q1-Q4 are grounded. The first to fourth signal output pins Y0-Y3 of the demultiplexer 30 are connected to the control terminals G1-G4 of the first to fourth electrical switches Q1-Q4, respectively. The signal input pin I of the demultiplexer 30 is set to be high level signal “1”. The two signal selecting pins L1 and L2 are connected to the two ID pins 23 and 24 of the sensor board 2 to select one signal output pin from the first to fourth signal output pins Y0-Y3, according to signals output by the two ID pins 23, 24, to output a control signal to the corresponding electrical switch.

In the embodiment, there are a first to a fourth types of sensor boards 2. The first to fourth types of sensor boards 2 each require different work voltages. The two ID pins 23, 24 of each type are set to different ID signals correspondingly, such as, the two ID pins 23, 24 are set to “00” on the first type sensor board 2; the two ID pins 23, 24 are set to “01” on the second type sensor board 2; the two ID pins 23, 24 are set to “10” on the third type sensor board 2; and the two ID pins 23, 24 are set to “11” on the fourth type sensor board 2. The first to fourth electrical switches Q1-Q4 are N type field-effect-transistors (FET). The control terminals G1-G4 are gates of the first to fourth FETs. The first terminals D1-D4 are drains of the first to fourth FETs. The second terminals S1-S4 are sources of the first to fourth FETs. Resistances of the second to fifth resistors R2-R5 are all different from each other.

When the first type sensor board 2 is connected to the motherboard 1, the motherboard 1 supplies the system voltage to the sensor board 2 as follows. The two ID pins 23 and 24 output the signal “00”. The two selecting pins L1 and L2 of the demultiplexer 30 receive the signal “00”. The demultiplexer 30 controls the first signal output pin Y0 to output a high level as the control signal to the control terminal G1 of the first electrical switch Q1, control the second to fourth signal output pins Y1-Y3 to output the low level as the control signal to the control terminal G2-G4 of the second to fourth electrical switches Q2-Q4. The first electrical switch Q1 is turned on, the voltage output terminal VOUT of the voltage converter 10 outputs the work voltage Vout=Vref*(1+R1/R2) to the voltage input terminal 22 of the sensor 20. If the sensor board 2 is the second, third, or fourth type, correspondingly, the second, third, or fourth electrical switch Q2, Q3, or Q4 is turned on. The voltage output terminal VOUT of the voltage converter 10 outputs the work voltage Vout=Vref*(1+R1/R3), Vout=Vref*(1+R1/R4), or Vout=Vref*(1+R1/R5) to the voltage input terminal 22 of the sensor 20. The reference voltage Vref is supplied by the voltage converter 10. The work voltages demanded by each type sensor board 2 can be obtained via selecting proper resistances of the first to fifth resistors R1-R5 and the reference voltage Vref of the voltage converter 10 according to the work voltage demanded by each type sensor board 2. The first and second capacitors C1 and C2 are used for filtering noise, and can be omitted to save manufacture cost.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An electronic device comprising:
a daughter board comprising an electrical element and a plurality of signal pins to output identity signals for denoting a type of the daughter board;
a motherboard supplying a system voltage for the daughter board, the motherboard comprising:
a controller receiving the identity signals from the signal pins of the daughter board to identify the type of the daughter board and outputting control signals according to the identity signals received from the daughter board; and
a voltage adjusting unit receiving the control signals and adjusting a voltage from a voltage source into a work voltage according the control signals, and outputting the work voltage to the electrical element.

2. The electronic device of claim 1, wherein the voltage adjusting unit comprises:
a voltage converter comprising a first terminal to receive the voltage from the voltage source, a second terminal and a third terminal;
a resistor regulator outputting a resistance to the second terminal of the voltage converter according to the control signals; and
a first resistor connected between the second and third terminals of the voltage converter, the third terminal of the voltage converter outputting the work voltage to the electrical element according to the resistance output by the resistor regulator and the resistance of the first resistor.

3. The electronic device of claim 2, wherein the resistor converter comprises a plurality of resistors and a plurality of electrical switches, each of the plurality of electrical switches correspond to one of the plurality of resistors, a first terminal of each resistor is connected to the second terminal of the voltage converter, a second terminal of each resistor is connected to a first terminal of the corresponding electrical switch, a second terminal of each electrical switch is grounded, a control terminal of each electrical switch is used to receive the control signals from the controller to turn on or off the corresponding electrical switch.

4. The electronic device of claim 3, wherein the controller is a demultiplexer, the demultiplexer receives the identity signals from the signal pins of the daughter board and outputs the control signals to turned on or off the plurality of switches.

5. The electronic device of claim 4, wherein the daughter board comprises two signal pins, the plurality of resistors comprises four resisters and the plurality of electrical switches comprises four electrical switches, the demultiplexer comprises two selecting pins connected to the signal pins of the daughter board, a signal input pin, and four signal output pins respectively connected to the four control terminals of the four electrical switches to output the control signals, to selectively turn on an electrical switch to output a corresponding resistance to the second terminal of the voltage converter.

6. The electronic device of claim 5, wherein each electrical switch is a N-taped field-effect-transistor (FET), the first terminal of the electrical switch is a source of the FET, the second terminal of the electrical switch is a drain of the FET, the control terminal of the electrical switch is a gate of the FET.

7. The electronic device of claim 1, wherein the electrical device is a network camera, the daughter board is a sensor board.

8. The electronic device of claim 1, wherein the plurality of signal pins of the daughter board is identity signal pins.

9. A motherboard for supplying a work voltage for an electrical element of a daughter board having identity (ID) pins which output ID signals to denote a type of the daughter board, the motherboard comprising:
a controller receiving the ID signals from the daughter board to identify the type of the daughter board and outputting control signals according to the ID signals;
a voltage converter comprising a first terminal connected to a voltage source to receive voltage, a second terminal and a third terminal;
a resistor regulator receiving the control signals and outputting a resistant signal to the second terminal of the voltage converter according to the control signals; and
a first resistor connected between the second and third terminals of the voltage converter, the third terminal of the voltage converter outputting the work voltage to the electrical element according to resistance output by the resistor regulator and the resistance of the first resistor.

10. The motherboard of claim 9, wherein the resistor converter comprises a plurality of resistors and a plurality of electrical switches, each of the plurality of electrical switches correspond to one of the plurality of resistors, a first terminal of each resistor is connected to the second terminal of the voltage converter, a second terminal of each resistor is connected to a first terminal of the corresponding electrical switch, a second terminal of each electrical switch is grounded, a control terminal of each electrical switch is used to receive the control signals from the controller to turn on or off the corresponding electrical switch.

11. The motherboard of claim 9, wherein the controller is a demultiplexer, the demultiplexer receives the ID signals from the ID pins of the daughter board and outputs the control signals to turn on or off the plurality of switches.

12. The motherboard of claim 10, wherein the plurality of resistors comprises four resistors and the plurality of four electrical switches comprises four electrical switches, the demultiplexer comprises two selecting pins connected to the ID pins of the daughter board, a signal input pin, and four signal output pins connected to the four control terminals of the four electrical switches to output the control signals, to selectively turn on an electrical switch to output a corresponding resistance to the second terminal of the voltage converter.

13. The motherboard of claim 12, wherein each electrical switch is an N-taped field-effect-transistor (FET), the first terminal of the electrical switch is a source of the FET, the second terminal of the electrical switch is a drain of the FET, the control terminal of the electrical switch is a gate of the FET.
